(19) United States
(12) Patent Application Publication
(10) Pub. No.: US 2016/0320176 A1
(43) Pub. Date: Nov. 3, 2016

(54) DIGITAL SHEAROGRAPHY NDT SYSTEM FOR SPECKLESS OBJECTS

(71) Applicant: OAKLAND UNIVERSITY, Rochester, MI (US)

(72) Inventors: Lianxiang Yang, Rochester Hills, MI (US); Xin Xie, Auburn Hills, MI (US); Nan Xu, Auburn Hills, MI (US); Xu Chen, Auburn Hills, MI (US)

(21) Appl. No.: 15/105,473

(22) PCT Filed: Dec. 19, 2014
(86) PCT No.: PCT/US14/71538

§ 371 Date: Jun. 16, 2016

Related U.S. Application Data
(60) Provisional application No. 61/919,050, filed on Dec. 20, 2013.

(51) Int. Cl. G01B 11/16; G01N 21/47; G01N 21/84

(52) U.S. Cl. CPC G01B 11/162; G01N 21/84; G01N 21/4788; G01N 2021/8472; G01N 2021/479

(57) ABSTRACT

A shearography system may include light source that may be configured to produce a beam of light to illuminate a test area, a camera, and an optical path between the light source and the camera, the test area disposed in the optical path between the light source and the camera. In embodiments, an image plane may be disposed in the optical path between the test area and the camera. In embodiments, the camera may be configured to obtain intensity information that may correspond to specular reflections of the beam of light off of the test area via diffuse reflections of the beam of light off of the image plane. The intensity information may correspond to out-of-plane strain of the test area.

### CROSS REFERENCE TO RELATED APPLICATION

This application claims the benefit of priority to U.S. Provisional application No. 61/919,050 filed 20 Dec. 2013, the entire disclosure of which is hereby incorporated by reference as though fully set forth herein.

### TECHNICAL FIELD

The present disclosure relates to methods and systems for non-destructive testing (NDT), which may include measuring stress, strain, and/or deformation. non-destructive testing may be used in a variety of applications, including manufacturing, biomedical, and microelectronics, among others. For example, aircrafts are often analyzed using shearography.

### BACKGROUND

Shearography, which may also be referred to as speckle pattern shearing interferometry, generally refers to a laser-based, whole field, non-contact and nondestructive optical method that may be capable of directly measuring strain information. Shearography systems may be used for non-destructive testing of composite materials, such as glass/carbon fiber reinforced materials, honeycomb structures, etc. As a laser interferometry technology, shearography may utilize speckle interferometry, which may use coherent light reflected from a rough test object surface. When the object under test is deformed, a speckle pattern captured by a sensor may be slightly altered. If two speckle patterns corresponding to deformed and undeformed state are obtained and subtracted, a fringe pattern, (e.g., a shearogram) may be generated.

In certain situations, conventional shearography systems may rely on the surface of the test object to be rough for a speckle pattern to be generated. If the test object surface is specular (e.g., mirror-like), most of the light reflected from the test object may be a specular reflection, which may limit the amount of speckle generated and may limit the effectiveness of conventional shearography systems. In some situations, the test object may be specially treated to provide a roughness to its surface. However, treating the test object may not be desirable or possible in all situations.

### SUMMARY

The present disclosure includes a shearography system that may comprise a light source configured to produce a beam of light to illuminate a test area, and the test area may include a speckless or quasi-speckless surface. In embodiments, the system may include a camera and an optical path between the light source and the camera. In embodiments, the test area may be disposed in the optical path between the light source and the camera. In embodiments, an image plane may be disposed in the optical path between the test area and the camera. In embodiments, the camera may be configured to obtain intensity information corresponding to a specular reflection of the beam of light off of the test area via a diffuse reflection of the specular reflection off of the image. In embodiments, the intensity information may correspond to an out-of-plane strain component of the test area.

In embodiments, a method of non-destructive testing may comprise providing a camera, a testing object, and a light source in an optical path; disposing an image plane in the optical path between the testing object and the camera; illuminating, via a beam from the light source, a test area of the testing object; reflecting the beam from the test area to the image plane; reflecting the beam from the image plane to the camera; capturing, via the camera, intensity information of the beam reflected from the image plane; and/or identifying a deformation in the test area according to the intensity information. In embodiments, the test area of the testing object may be speckless or quasi-speckless, and the image plane may include a surface configured for diffuse reflection that may be disposed in the optical path between the test area and the camera.

Various aspects of this disclosure will become apparent to those skilled in the art from the following detailed description of embodiments of the present disclosure, when read in light of the accompanying drawings.

### BRIEF DESCRIPTION OF THE DRAWINGS

FIG. 1 is a schematic view of an embodiment of a shearography system in accordance with teachings of the present disclosure.

FIG. 1A is a simplified schematic of portions of an embodiment of a shearography system in accordance with teachings of the present disclosure.

FIG. 1B is a pair of simplified plots of the phase of reflections of a beam of light reflecting from a testing object an embodiment of a shearography system in accordance with teachings of the present disclosure.

FIG. 2 is a partial schematic view of an embodiment of a shearography system in accordance with teachings of the present disclosure.

FIG. 3 is a partial schematic view of an embodiment of a shearography system in accordance with teachings of the present disclosure.

FIGS. 4A and 4B are phase maps of a conventional shearography system.

FIGS. 5A and 5B are phase maps of an embodiment of a shearography system in accordance with teachings of the present disclosure.

FIGS. 6A and 6B are phase maps of an embodiment of a shearography system in accordance with teachings of the present disclosure.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by appended claims.

The present disclosure includes a shearography system 10. In embodiments, shearography system 10 may be referred to as a digital speckle pattern shearing interferometry system and may be used for non-destructive testing (NDT) to analyze properties of various materials, such as, for example, composite materials. In embodiments, shearography system 10 may be configured for laser-based, full field, non-contact optical measurement of strain (e.g., out-of-plane strain) with a sensitivity of several microstrains.

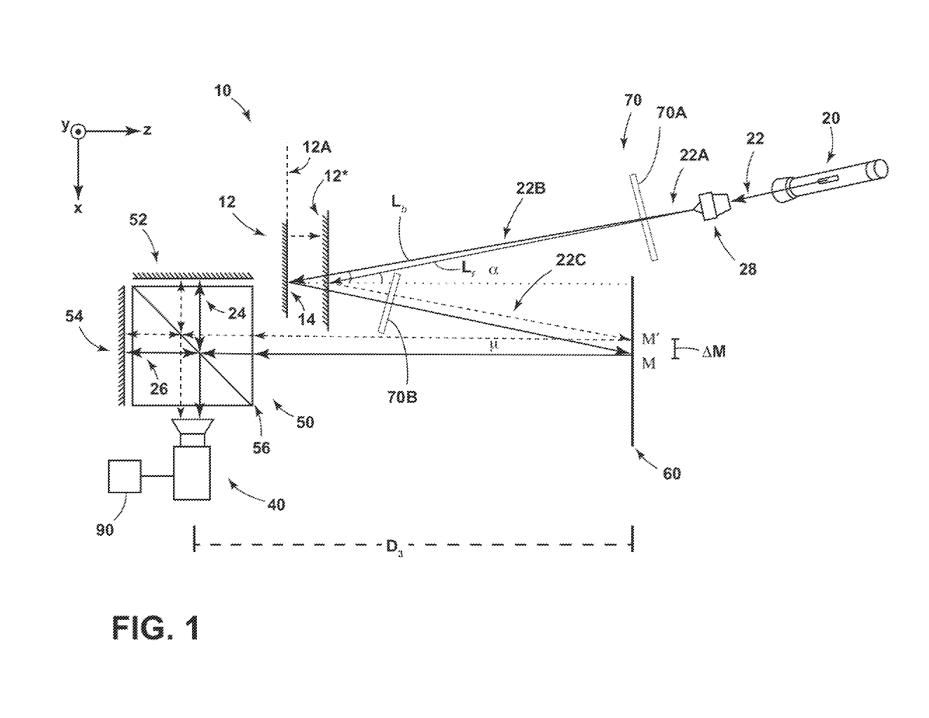

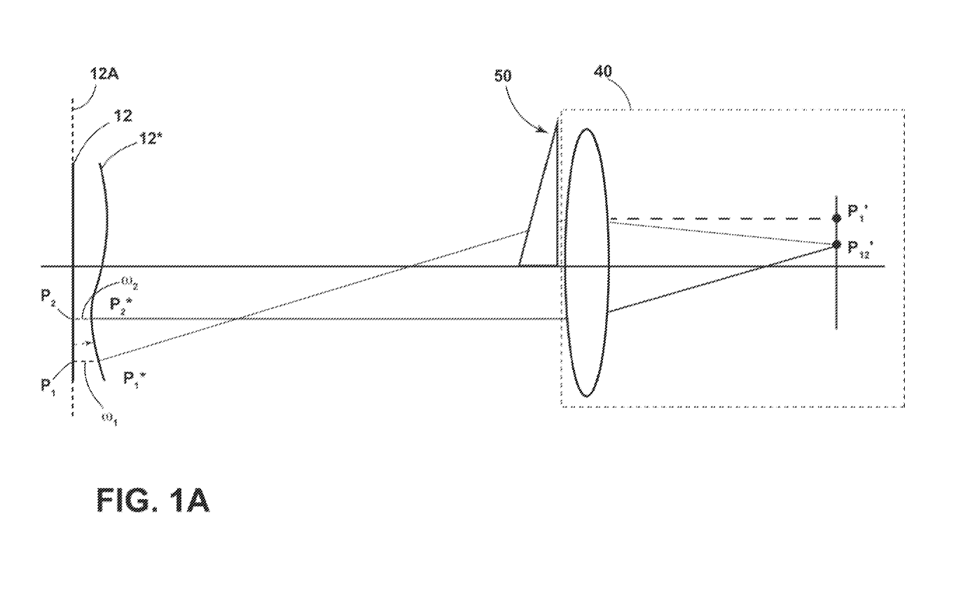

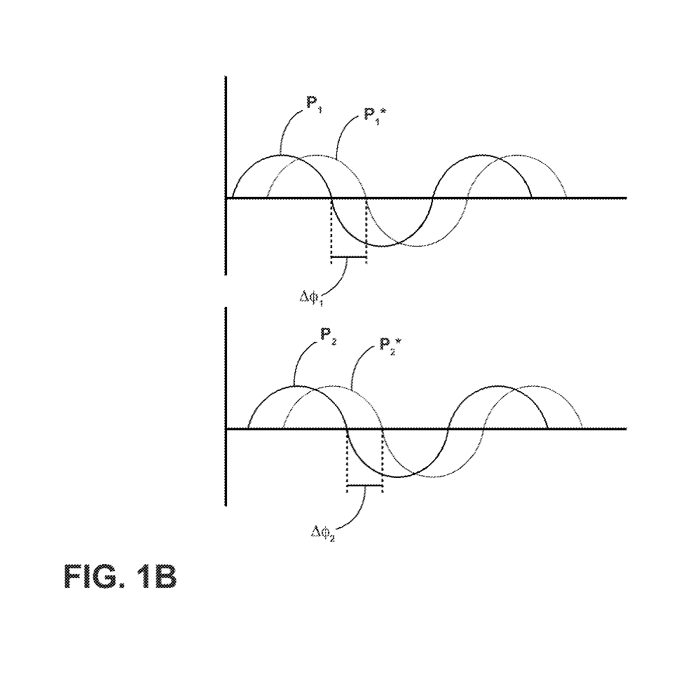

As generally illustrated in FIG. 1, in embodiments, shearography system 10 may include a light source 20, a detector 40, an optical device 50, an image plane 60, and/or one or more polarizers 70. In embodiments, light source 20 may be configured to illuminate a testing object 12. Testing object 12 may include a first state, which may correspond to a reference, unloaded, and/or non-deformed state. Additionally or alternatively, testing object 12 may include a second state, which may include a loaded and/or deformed state. In embodiments, second state of testing object 12 may include one or more of a variety of loads and/or deformations.

In embodiments, light source 20 may illuminate testing object 12, which may allow detector 40 to capture a reference image (e.g., a reference shearogram). A reference shearogram may correspond to a beam 22 from light source 20 illuminating testing object 12 and may be captured by detector 40 via optical device 50. Light source 20 may then illuminate testing object 12 again, but with testing object 12 in its second state, which may allow for generating a corresponding testing image (e.g., a testing shearogram). Comparing a reference image with a testing image may allow for a determination of relative phase difference information Δφ, which may be used to measure stress, strain, and/or deformation, and/or locate faults in a material. Determining phase difference information from reference and testing images/intensities may be accomplished in one or more of a variety of ways. For example, and without limitation, phase difference information may be determined via fringe counting, temporal phase shifting, and/or spatial phase shifting, such as described in PCT Application PCT/US2014/062610, filed Oct. 28, 2014 and U.S. Provisional Patent Application 61/896,391, filed Oct. 28, 2013, both of which are hereby incorporated by reference as though fully set forth herein.

In embodiments, light source 20 may be configured to emit convergent, generally convergent, and/or partially convergent light, such as, for example, as a beam 22. In embodiments, light source 20 may include a laser, beam 22 may be configured as a laser beam, and/or beam may be referred to herein as laser beam 22. In embodiments, light source 20 may include a helium-neon (HeNe) laser, which may be configured to emit a laser beam including a wavelength of about 630 nm, for example, 632.8 nm. For example, and without limitation, beam of light 22 may be configured as a laser with a wavelength of about 632.8 nm. Additionally or alternatively, light source 20 may include a green laser, which may be configured to emit a laser beam including a wavelength of about 532 nm. For example, and without limitation, beam of light 22 may be configured as a laser with a wavelength of about 532 nm. In embodiments, light source 20 may be configured to illuminate testing object 12 and/or may be configured to direct beam of light 22 toward testing object 12.

In embodiments, shearography system 10 may include one or more beam expanders 28. A beam expander 28 may be configured to expand a beam of light (e.g., beam 22) into an expanded beam of light, such as, for example, beam of light into expanded first beam of light 22A. Beam expander 28 may be disposed in an optical path between a light source 20 and testing object 12. An expanded beam of light may illuminate a larger area of testing object 12, which may permit evaluation and/or strain measurement of a larger area of testing object 12.

In embodiments, detector 40 may be configured to detect, receive, capture, and/or measure light and/or the intensity of light. Detector 40 may also be referred to herein as camera 40. In embodiments, camera 40 may include a charge-coupled device (CCD). A CCD may be configured to determine a value of light intensity provided to it. In embodiments, for example only, intensity may be measured on a scale of 0 to 255 and/or intensity information may include a value between 0 and 255, inclusive. In embodiments, a shearography system 10 may include a single camera 40 or a plurality of cameras 40.

In embodiments, camera 40 may include a high speed camera, such as, for example, a camera capable of capturing at least 15,000 frames per second (fps). A high speed camera may allow a shearography system 10 to include a dynamic measurement range of up to and/or exceeding 7.5 kHz.

In embodiments, camera 40 may be configured to obtain intensity information about light that it receives (e.g., beam of light 22). The obtained intensity information may be processed by processing unit 90. Processing unit 90 may comprise a processor and/or may be referred to herein as processor 90. Processor 90 may comprise a programmable microprocessor and/or microcontroller, and/or may include, for example, an application specific integrated circuit (ASIC). Processor 90 may include a central processing unit (CPU), memory, and/or an input/output (I/O) interface. Processor 90 may be configured to perform various functions, including those described in greater detail herein, with appropriate programming instructions and/or code embodied in software, hardware, and/or other medium. For example, and without limitation, camera 40 may be configured generate one or more electrical signals corresponding to measured intensity and processor 90 may be configured to receive and/or process the signal or signals.

In embodiments, shearography system 10 may include an optical device 50. In embodiments, optical device 50 may include an interferometer, such as, for example, a Michelson interferometer. In embodiments, optical device 50 may be configured for shearing and/or may be configured as a modified Michelson interferometer, which may include at least one element of the Michelson interferometer being disposed at an oblique angle relative to a second element. In embodiments, camera 40 may include portions and/or all of optical device 50. As generally illustrated in FIG. 1, in embodiments, optical device 50 may include a first element 52, a second element 54, and/or a third element 56. First element 52 may be configured to reflect light, may include a mirror, and/or may be referred to herein as mirror 52. Second element 54 may configured to reflect light, may include a mirror and/or may be referred to herein as mirror 54. Mirror 52 and mirror 54 may be disposed in a generally perpendicular orientation relative to one another. In embodiments, such as in a spatial phase shift configuration, optical device 50 may be configured to provide a shearing angle, which may include at least one of mirrors 52, 54 may be disposed such that it is not perpendicular relative to the other mirror. For example, mirror 52 may be disposed at an angle relative to mirror 54, and the angle may comprise an oblique angle. In embodiments, optical device 50 may be disposed in an optical path (e.g., optical paths, L_{b}, L_{f}) between light source 20 and camera 40, and/or between image plane 60 and camera 40.

In embodiments, third element 56 may include a beam splitter and/or may be referred to herein as beam splitter 56. Beam splitter 56 may include one or more of a variety of configurations. For example, and without limitation, beam splitter 56 may include a cube, which may include two triangular prisms joined together, and/or beam splitter 56 may include a half-silvered element. Beam splitter 56 may be configured such that all of, a portion of, or none of the light that is directed to beam splitter 56 passes through beam splitter 56. In embodiments, beam splitter may be configured to reflect light that does not pass through it. In embodiments, beam splitter 56 may be configured to reflect a first portion 24 of beam 22 toward mirror 52. Additionally or alternatively, beam splitter 56 may be configured to receive beam 22 and allow a second portion 26 of first beam 22 to pass through to mirror 54. In embodiments, beam splitter 56 may be configured to allow first portion 24 of beam 22, which may include about half of beam 22, to pass through to mirror 54, and/or beam splitter 56 may be configured to reflect second portion 26, which may include about half of first beam, toward mirror 52. Beam splitter 56 may, additionally or alternatively, be configured to allow light reflected from mirror 52 (e.g., beam first portion 24) to pass through toward camera 40 as a first wave front and/or reflect light reflected from mirror 56 (e.g., beam second portion 26) toward camera 40 as a second wave front.

In embodiments, a surface of test area 14 of testing object 12 may be speckless, quasi-speckless, may be at least partially shiny, and/or be at least partially mirrored. Reflections from such surfaces may be difficult to analyze and/or evaluate for conventional shearography systems. In embodiments, shearography system 10 may include an image plane 60. Image plane 60 may include one or more of a variety of shapes sizes and/or configurations. For example, and without limitation, image plane may include a metal plate. In embodiments, image plane 60 may be configured for diffuse reflection of light that reaches it, which may include having rough and/or generally white surface. In embodiments, image plane 60 may be configured for diffuse reflection of light (e.g., beam 22) that reaches it. For example, in embodiments, beam 22 may reach image plane 60 and may be subject to diffuse reflection from image plane 60 in a plurality of directions generally toward optical device 50. Image plane 60 may be disposed in an optical path (e.g., paths L_{b}, L_{f}) between testing object 12 and optical device 50 and/or camera 40. For example, and without limitation, light source 20 may emit beam of light 22 toward testing object 12 and beam of light 22 may reflect (e.g., at least partially in a specular manner) off of testing object 12 toward image plane 60. Beam of light 22 arriving at image plane may result in a speckle pattern on image plane 60. Camera 40, via optical device 50, may be configured to capture the speckle pattern of beam of light 22 on image plane 60. In embodiments, an image plane incident angle may be represented by μ.

In embodiments, such as if test area 14 of testing object 12 is not entirely speckless, beam of light 22 may at least partially subjected to diffuse reflection from test area 14 (e.g., a generally specular reflection may include diffuse portions and specular portions). Diffuse reflection of beam of light 22 off of test area 14 may interfere with the speckle pattern created by specular reflection of beam of light 22 on image plane 60. In embodiments, shearography system 10 may include one or more polarizers 70, which may include orthogonal polarizers. A polarizer 70 may be configured to eliminate and/or reduce the effects of portions of beam of light 22 that may be subject to diffuse reflection when emitted from light source 20 (e.g., a first polarizer 70A may prevent diffuse reflections/portions of beam 22 from reaching test area 14). In embodiments, first polarizer 70A may be disposed in an optical path (e.g., paths L_{b}, L_{f}) between light source 20 and testing object 12. In embodiments, after beam 22 passes through polarizer 70A (e.g. beam portion 22B), beam 22 may comprise primarily specular light. In embodiments, a second polarizer 70B may be disposed between (e.g., physically between and/or in an optical path between) testing object 12/testing area 14 and image plane 60. Polarizer 70B may be configured to eliminate and/or reduce the effects of portions of beam of light 22 that may be subject to diffuse reflection from testing object 12 (e.g., polarizer 70B may prevent diffuse reflections/portions of beam 22 from reaching image plane 60). In embodiments, after beam 22 passes through polarizer 70B (e.g. beam portion 22C), beam 22 may comprise primarily specular light.

In embodiments, a certain amount of beam of light 22 may be subject to diffuse reflection from a generally speckless testing object 12, but such light may not be as strong as light that may be subject to diffuse reflection from a rough and/or quasi-speckless surface, and/or such light may be relatively insignificant and/or negligible.

In embodiments, such as generally illustrated in FIGS. 1-3, beam of light 22 may follow a first optical path L_{b} if testing object 12 is in a first (e.g., reference) state and/or may follow a second path L_{f} if testing object 12 is in a second (e.g., test) state. First optical path L_{b} may extend from light source 20 to testing object 12 in its first state. First optical path L_{b} may then extend to image plane 60 (e.g., test area 14 of test object 12 may be disposed between light source 20 and camera 40). From image plane 60, first optical path L_{b} may extend to optical device 50 and then to camera 40. In embodiments, the portions of first optical path L_{b} between image plane 60 and camera 40 may be the same in the first state and second state of testing object 12 and/or may be omitted and/or ignored for purposes of determining strain.

In embodiments, second optical path L_{f} may follow a similar progression as first optical path L_{b}, but testing object 12 may be disposed at a distance and/or angle θ₁ (e.g., an oblique angle) relative to testing object 12 in its first (e.g., reference) state. A change in position of testing object 12 may result from loading or unloading of testing object 12 and the amount of change may be unknown and/or may not be easily discernable to the human eye. A change in position of testing object 12 in its second (e.g., testing state) relative to its first (e.g., reference) state may cause second optical path L_{f} to be offset from first optical path L_{b}. The offset of second optical path L_{f} from first optical path L_{b} may correspond to an amount of deformation of the testing object 12.

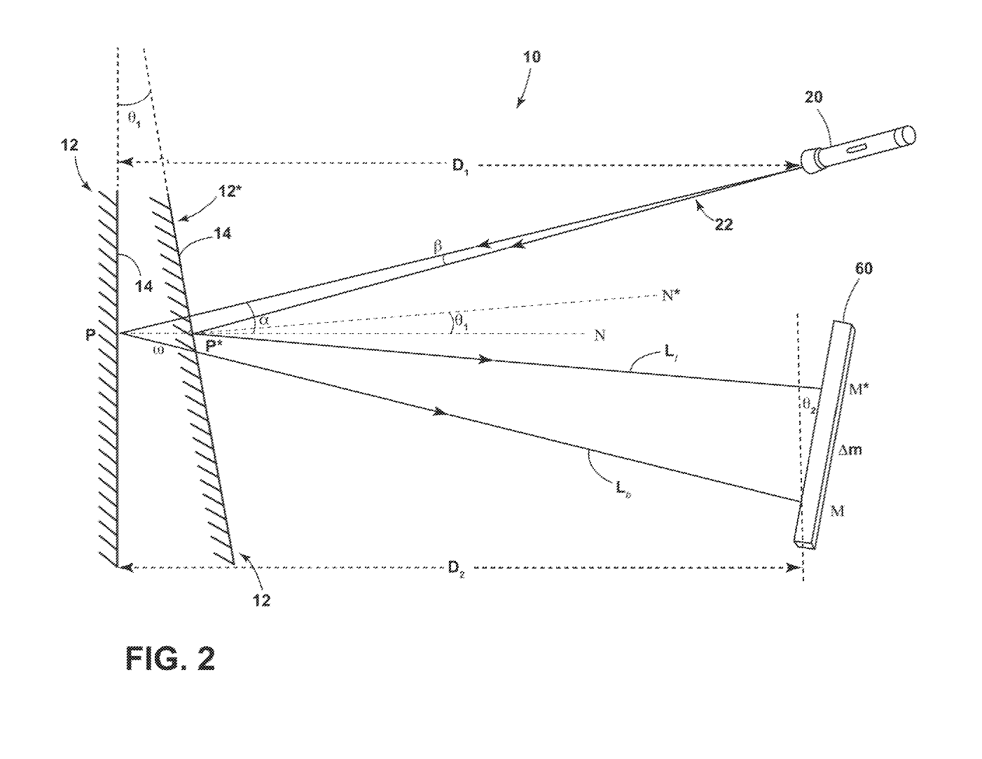

In embodiments, such as generally illustrated in FIG. 2, a point P on test area 14 of testing object 12 may be a testing point and/or a point M may correspond to point P on the image plane 60. Line PN may correspond to the normal line at point P. A distance D₁ may correspond to the distance between light source 20 and testing object 12. A distance D₂ may correspond to the distance between the testing object 12 and the image plane 60. An amount of deformation ω may correspond to an amount of out-of-plane deformation of testing object at point P. A point P* on testing object 12 may correspond to point P after deformation (e.g., via loading) of testing object 12. An angle θ₁ may correspond to the turning angle of testing object 12 at point P due to deformation. An angle θ₂ may correspond to a tilting angle of image plane 60 relative to a plane 12A of testing object in its reference state. An angle α may correspond to an incident/illumination angle of light source 20 relative to testing object 12. An angle β may correspond to an incident turning angle and/or a change in the illumination angle (e.g., relative to illumination angle α) that may result from deformation. A line P*N* may correspond to a line normal to testing object 12 in its testing state at point P*. A point M′ may correspond to point P* on the image plane 60. A shift Δm may correspond to an amount of an image shift on image plane 60 between the reference state and testing state of testing object 12, which may correspond to the distance between point M and point M′. Image shift Δm may be caused by disposed image plane 60 in optical paths L_{b}, L_{f}.

In embodiments, a distance D₃ between image plane 60 and optical device 50 may not change during a transition of testing object 12 between its reference state and its testing state (e.g., during loading and/or unloading). In embodiments, first optical path L_{b} may be represented by the following equation:

$${L}_{b} = \frac{{D}_{1}}{cos α} + \frac{{D}_{2}}{cos α} . \qquad Eq . 1$$

As generally illustrated in FIG. 2, if testing object 12 is deformed, a line normal to the surface of testing object may turn by angle θ₁ (e.g., line PN may turn by angle θ₁ to line P*N*). A turn may cause image shift Δm on image plane 60. Image shift Δm may be represented by the following equation:

$$Δ m = {D}_{2} \frac{sin α}{cos ( α - {θ}_{2} )} - ( {D}_{2} - ω ) \frac{sin ( α + β - 2 {θ}_{1} )}{cos ( α + β - {θ}_{2} - 2 {θ}_{1} )} . \qquad Eq . 2$$

In embodiments, image shift Δm may alter a calculation of out-of-plane strain, but image shift Δm may not materially affect generating a phase map for locating faults and/or deformations in a material. In embodiments, after deformation and image shift Δm, second optical path L_{f} may be represented by the following equation:

$${L}_{f} = \frac{{D}_{1} - ω}{cos ( α + β )} + \frac{( {D}_{2} - ω + {D}_{2} tan α tan {θ}_{2} + D 2 ) sin {θ}_{2}}{sin ( 2 {θ}_{1} + {θ}_{2} - α - β )} . \qquad Eq . 3$$

In embodiments, incident angle α may be close to zero degrees, which may result in angle β also being close to 0 (see, e.g., Equation 5, below). A difference between first optical path L_{b} and second optical path L_{f} may be represented by the following equation:

$$Δ L = \frac{{D}_{1}}{cos α} - \frac{( {D}_{1} - ω )}{cos ( α + β )} + \frac{{D}_{2} cos ( {θ}_{2} )}{cos ( α - {θ}_{2} )} - \frac{{D}_{2} ( 1 + tan α tan {θ}_{2} ) - ω}{cos ( α + β - 2 {θ}_{1} - {θ}_{2} )} . \qquad Eq . 4$$

In embodiments, incident angle α, may change by incident angle change β. In embodiments, angle β may be represented by the following equation:

$$β = arctan \frac{ω sin α cos α}{{D}_{1} - ω {cos}^{2} α} . \qquad Eq . 5$$

In embodiments, distance D₁ may be significantly larger than the size of testing object 12, so angle α may be relatively close to zero degrees, which may result in cos² α being close to 1. In such embodiments, Equation 5 may simplify to the following:

$$β = arctan \frac{ω sin 2 α}{2 ( {D}_{1} - ω )} . \qquad Eq . 6$$

In embodiments, a relationship between optical path difference ΔL and out-of-plane deformation ω may be represented in Equation 4.

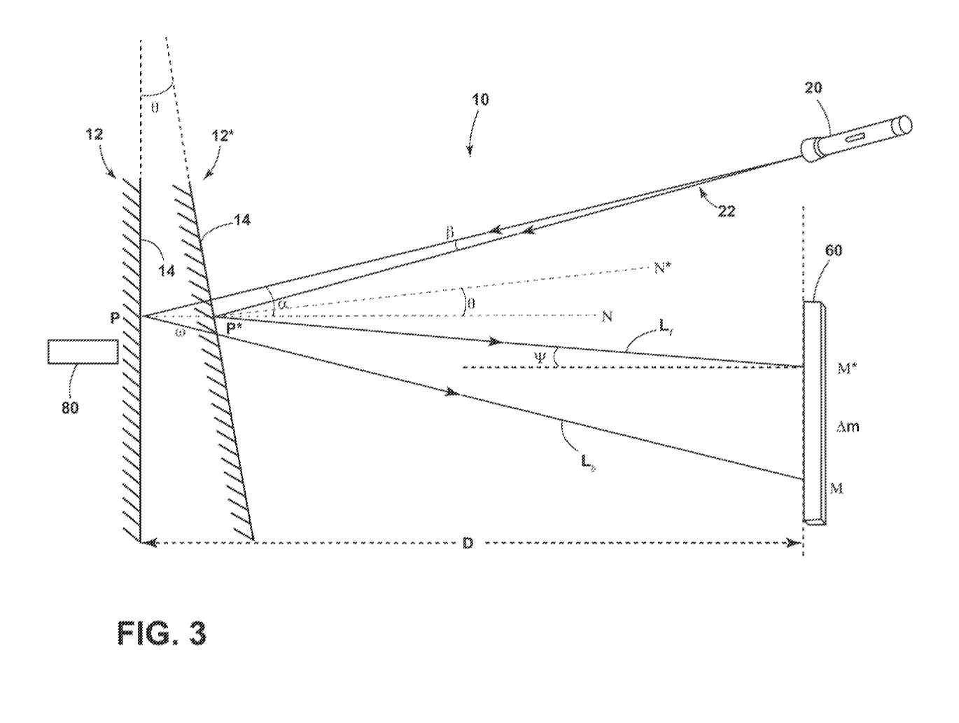

In embodiments, such as generally illustrated in FIG. 3, shearography system 10 may be configured such that image plane 60 is disposed substantially parallel to testing object 12 and/or such that light source 20 is generally aligned with the image plane 60. In such embodiments, D₁ and D₂ may be substantially equal and may be represented by D, and/or θ₂ may be substantially zero. In embodiments in which image plane 60 is substantially parallel to testing object 12, a difference between first optical path L_{b} and second optical path L_{f} may be represented by a simplified equation:

$$Δ L = ( D - ω ) ( \frac{1}{cos ( α + β )} + \frac{1}{cos ( α + β - 2 θ )} ) - \frac{2 D}{cos α} . \qquad Eq . 7$$

where ω corresponds to out-of-plane deformation, D corresponds to the distance from light source 20 to testing object 12 and from testing object 12 to image plane 60, α corresponds to the incident angle of light source 20, β corresponds to change of the incident angle α that may result from deformation, and β corresponds the tilting angle of testing object 12 at point P* that may result from deformation. Additionally or alternatively, in such embodiments, Equation 2, which may represent image shift distance Δm on image plane 60 due to deformation, may be simplified to the following equation:

Δm=D tan α−(D−ω)tan(Ψ−θ) Eq. 8.

In embodiments, Equation 7 may be simplified by substituting Ψ=α+β−θ. In embodiments, such as generally illustrated in FIG. 3, Ψ may represent the incident angle after deformation, and substitution may result in the following equation:

$$Δ L = ( D - ω ) ( \frac{1}{cos ( Ψ + θ )} + \frac{1}{cos ( Ψ - θ )} ) - \frac{2 D}{cos α} . \qquad Eq . 9$$

In embodiments, incident angle α may be relatively small (e.g., close to 0). In such embodiments, β may approach 0 according to Equation 5. In such embodiments, an optical path difference ΔL may be represented via a simplified equation:

$$Δ L = 2 ( D - ω ) \frac{{cos}^{2} θ}{cos ( 2 θ )} - 2 D . \qquad Eq . 10$$

In embodiments, Equation 10 may, additionally or alternatively, be represented by the following equation:

$$Δ L = 2 \frac{D {sin}^{2} θ - ω {cos}^{2} θ}{{cos}^{2} θ - {sin}^{2} θ} . \qquad Eq . 11$$

In embodiments, camera 40 and/or light source 20 may be disposed in the X-Z plane and/or the size of test area 14 of testing object 12 may be much smaller than the distance from testing object 12 to camera 40 (e.g., via image plane 60) and/or distance D₁ from testing object 12 to light source 20. In embodiments, relative phase change Δφ may correspond to a difference between a first phase change Δφ₁ and a second phase change Δφ₂. Phase change Δφ₁ and phase change Δφ₂ may correspond to beam of light 22 on the surface of testing object 12 scattering, as a result of loading, from two arbitrary points (e.g., points P1 and P₂) on the surface of testing object 12. In embodiments, such as generally illustrated in the simplified (e.g., shown without an image plane 60) diagram of FIG. 1A, points P₁ and P₂ may correspond to an interferometry point pair in shearography that may be disposed at arbitrary locations on the surface of testing object and/or points P₁* and P₂* may correspond to points P₁ and P₂ on a deformed test object 12*. In embodiments, light reflected from points P₁ and P₂ may reflect toward optical device 50 and/or camera 40. In embodiments, such as generally illustrated in FIG. 1A, optical device 50 may redirect a reflection from P₁* (e.g., from reaching point P₁′) such that reflections from P1* and P₂* overlap (e.g., at point P₁₂′) within camera 40. Reflections from points P1 and P2 may follow a similar path (e.g., to overlap at a point on image plane 6), but are not shown in FIG. 1A for simplicity. Phase change Δφ₁ and/or phase change Δφ₂ may correspond to light beam 22 on the surface of testing object 12 scattered from a respective point on testing object 12 due to loading. In embodiments, Δφ may represent a relative phase change due to deformation and may be expressed as:

$$\begin{matrix}Δφ = {Δφ}_{1} - {Δφ}_{2} \\ = \frac{2 π}{λ} ( 2 \frac{D {sin}^{2} θ - {ω}_{1} {cos}^{2} θ}{{cos}^{2} θ - {sin}^{2} θ} - 2 \frac{D {sin}^{2} θ - {ω}_{2} {cos}^{2} θ}{{cos}^{2} θ - {sin}^{2} θ} ) \\ = \frac{2 π}{λ} ( 2 \frac{δω {cos}^{2} θ}{cos 2 θ} )\end{matrix} . \qquad Eq . 12$$

where Δφ₁ and Δφ₂ represent the phase difference at points P₁ and P₂ (see, e.g., FIG. 1B), respectively, ω₁ and ω₂ represent the out-of-plane deformations at points P₁ and P₂, respectively, and δω corresponds to the difference between ω₁ and ω₂. In embodiments, phase information, such as phase change Δφ, a first phase change Δφ₁, and/or a second phase change Δφ₂ may be determined via light intensity information obtained by camera 40. For example, and without limitation, camera 40 may be configured to obtain reference intensity information that may correspond to the intensity of beam 22 received by camera if testing object 12 is in a reference state. In embodiments, the reference intensity information may correspond to specular reflection of beam 22 off of test area 14 (e.g., in its reference state) via diffuse reflection of beam 22 off of image plane 60. Additionally or alternatively, camera 40 may be configured to obtain testing intensity information that may correspond to the intensity of beam 22 received by camera if testing object is in a testing state. In embodiments, the reference intensity information may correspond to specular reflection of beam 22 off of test area 14 (e.g., in its testing state) via diffuse reflection of beam 22 off of image plane 60.

In embodiments, the shearing direction may be in the x-direction. In embodiments, both sides of Equation 12 may be divided by a shearing amount δx, which may result in the following equation:

$$Δφ = \frac{2 π}{λ} \frac{2 {cos}^{2} θ}{cos 2 θ} \frac{δω}{δ x} δ x . \qquad Eq . 13$$

In embodiments, Equation 13 may be simplified to the following equation:

$$Δφ = \frac{4 π}{λ} \frac{1}{1 - {tan}^{2} θ} \frac{δω}{δ x} δ x . \qquad Eq . 14$$

In embodiments, tan θ may equal δω/δx, so tan² θ may equal (δω/δx)², which may be relatively small and/or relatively close to 0. In such embodiments, Equation 14 may be further simplified to the following equation:

$$Δφ = ( \frac{4 π}{λ} δ x ) \frac{δω}{δ x} . \qquad Eq . 15$$

In embodiments, the shearing direction may be in the y-direction, which may result in the following phase difference equation:

$$Δφ = ( \frac{4 π}{λ} δ y ) \frac{δω}{δ y} . \qquad Eq . 16$$

In embodiments, if a shearing amount is relatively small, Equation 15 and Equation 16 may be simplified to the following equations, respectively:

$$\begin{matrix}Δφ = ( \frac{4 π}{λ} δ x ) \frac{\partial ω}{\partial x} . & Eq . 17 \\ Δφ = ( \frac{4 π}{λ} δ y ) \frac{\partial ω}{\partial y} . & Eq . 18\end{matrix}$$

In embodiments, Equation 17 and/or Equation 18 may be solved for out-of-plain strain in a shearing direction

$$( e . g . , \frac{\partial ω}{\partial x} , \frac{\partial ω}{\partial y} ) .$$

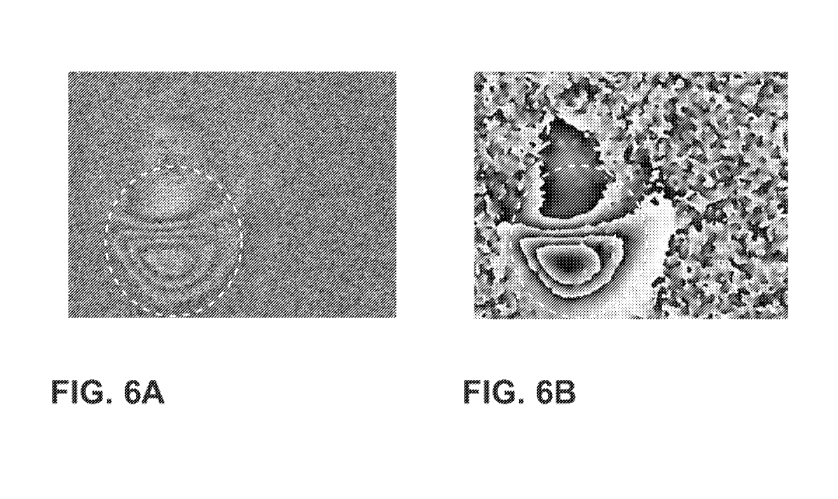

In embodiments, processing unit 90 may be connected to camera 40 and/or may be configured to display the intensity information via phase maps (e.g., as generally illustrated in FIGS. 5A-6B). Phase maps may permit identification of deformations and/or determination of phase information (e.g., by counting fringes). Additionally or alternatively, processing unit 90 may be configured to determine phase information from intensity information and/or out-of-plane strain measurement of test area 14 from phase information (e.g., intensity information that may be obtained by camera 40 may correspond to out-of-plane strain and/or relative phase difference information). For example, and without limitation, processing unit 90 may be configured to determine reference phase information from reference intensity information, testing phase information from testing intensity information, and/or relative phase difference information from the reference phase information and testing phase information. In embodiments, processing unit 90 may be configured to obtain phase information from intensity information via one or more of a variety of methods, such as, for example, temporal phase shifting and/or spatial phase shifting.

In embodiments, processing unit 90 may be configured to determine out-of-plane strain of testing object 12 that may be caused by deformation according to the relative phase difference information (which may correspond to and/or include reference phase information and testing phase information). Processing unit 90 may be configured to carry out one or more of Equations 1-16, which may permit processing unit 90 to determine and/or calculate out-of-plane strain.

In embodiments, a method of determining strain may include securing a testing object 12, such as, for example, via clamping a metal-coated plate to a steel frame. A load may be applied to testing object 12 via a loading device 80. In embodiments, loading device 80 may comprise a micro-head installed backward to apply a centrally concentrated loading to the testing object 12 from behind. Such a load may generate a cone-shaped deformation of the testing object 12.

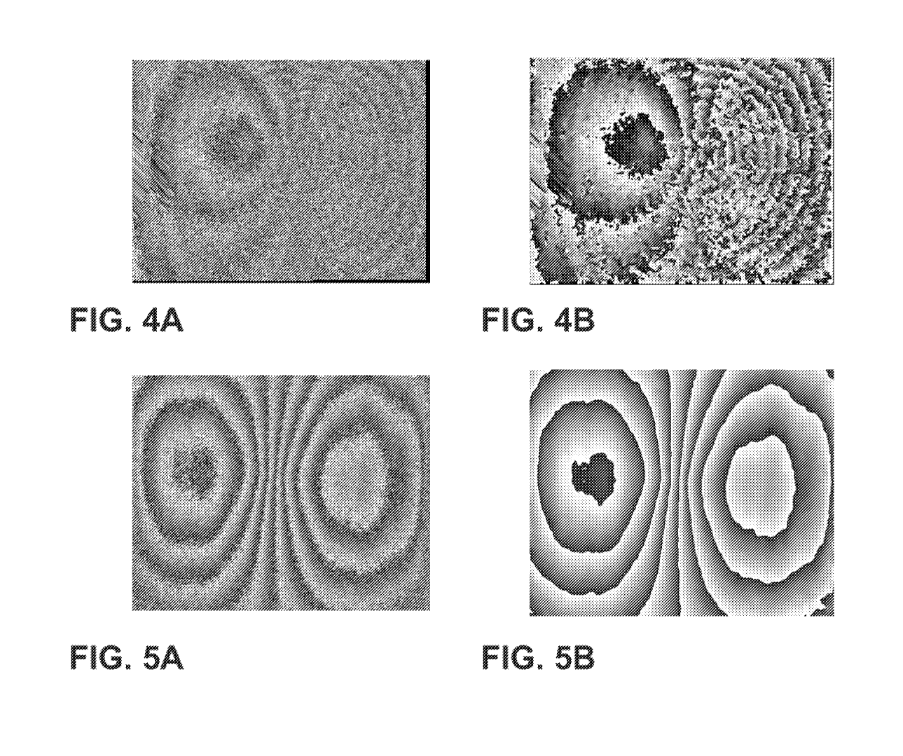

As generally illustrated in FIGS. 4A and 4B, conventional shearography systems may produce relatively low quality results when used with speckless and/or quasi-speckless test areas of testing objects relative to embodiments of shearography system 10 (e.g., as illustrated in FIG. 5A and a smoothed version in FIG. 5B). Low quality results from conventional shearography systems may be at least partially due to a relatively small amount of diffuse light reflecting from speckless and/or quasi-speckless surface and/or being available for generating speckles or carrying information. Instead, much of the available light may be subject to specular reflection. In some configurations, deforming a testing object (e.g., testing object 12) may change an incident angle, which may increase specular reflection of light to a camera and/or may obscure phase information that might otherwise be obtained by the camera. In contrast, in embodiments of shearography system 10, image plane 60 may allow for an increased amount of diffuse reflection of beam 22 to be received by camera 40 and/or may allow for phase information to be determined.

In embodiments, testing object 12 may comprise a piece of an aluminum skinned honeycomb structure composite material that may include a small delamination area 16. Testing object 12 may be supported on an optical table. The aluminum skin may include a quasi-speckless surface and/or shearography system 10 may include one or more orthogonal polarizers 70A, 70B that may be configured to polarize beam 22. In embodiments, loading device 80 may comprise a heat gun and/or may be configured to heat testing object 12. Heat from loading device 80 may deform the small delamination area 16 differently (e.g., more, less, etc.) than other areas, which may allow for the delamination area 16 to be detected. As generally illustrated in FIG. 6A, a fringe pattern that may generated via shearography system 10 may reveal delamination area 16. FIG. 6B generally illustrates a smoothed version of the fringe pattern of FIG. 6A. In embodiments, if shearography system 10 is used on an aircraft fuselage, for example, shearography system 10 may be able to accurately identify delamination areas (e.g., delamination area 16) without causing damage to the fuselage.

The foregoing descriptions of specific embodiments of the present disclosure have been presented for purposes of illustration and description. They are not intended to be exhaustive or to limit the invention to the precise forms disclosed, and various modifications and variations are possible in light of the above teaching. It should be understood that references to a single element are also intended to include embodiments that may include more than one of that element or zero of that element. It should also be understood that references to directions, such as vertical, horizontal, top, bottom, are provided for illustrative purposes only and are not intended to limit the scope of the disclosure.

Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present teachings not be limited to the particular examples illustrated by the drawings and described in the specification. It is intended that the scope of the invention be defined by the claims and their equivalents.

What is claimed is:

1. A shearography system comprising:
a light source configured to produce a beam of light to illuminate a test area, the test area including a speckless or quasi-speckless surface;
a camera;
an optical path between the light source and the camera, the test area disposed in the optical path between the light source and the camera;
an image plane disposed in the optical path between the test area and the camera,
wherein the camera is configured to obtain intensity information corresponding to a specular reflection of the beam of light off of the test area via a diffuse reflection of the specular reflection off of the image.

2. The shearography system of claim 1, comprising a processor connected to the camera, wherein the processor is configured to process the intensity information obtained by the camera to produce and/or obtain a phase map.

3. The shearography system of claim 2, wherein the processor is configured to provide and/or determine relative phase change information between a reference state of the test area and a test state of the test area.

4. The shearography system of claim 3, wherein the processor is configured to provide and/or determine out-of-plane strain of the test area according to the relative phase change information.

5. The shearography system of claim 1, wherein the test area includes a quasi-speckless surface.

6. The shearography system of claim 1, wherein the test area includes a speckless surface.

7. The shearography system of claim 1, wherein the image plane includes a rough surface.

8. The shearography system of claim 2, wherein the image plane includes a rough surface.

9. The shearography system of claim 7, wherein the rough surface is white.

10. The shearography system of claim 1, comprising a first polarizer disposed in the optical path between the test area and the image plane.

11. The shearography system of claim 10, comprising a second polarizer disposed in the optical path between the light source and the test area.

12. The shearography system of claim 8, comprising a polarizer disposed in the optical path between the light source and the test area.

13. The shearography system of claim 10, wherein the first polarizer is an orthogonal polarizer.

14. The shearography system of claim 13, wherein the specular reflection off of the test area includes diffuse portions and specular portions, and the first polarizer is configured to prevent the diffuse portions from reaching the image plane.

15. The shearography system of claim 14, wherein the test area includes a quasi-speckless surface.

16. The shearography system of claim 11, wherein the beam of light includes diffuse portions and specular portions, and the second polarizer is configured to prevent the diffuse portions from reaching the test area.

17. The shearography system of claim 1, wherein the image plane causes and/or creates an image shift.

18. The shearography system of claim 1, wherein the intensity information includes reference intensity information and testing intensity information, the reference intensity information corresponds to a reflection of the beam of light off of the test area and the image plane while the test area is in a reference state, and the testing intensity information corresponds to a reflection of the beam of light off of the test area and the image plane while the test area is in a testing state.

19. The shearography system of claim 18, wherein the testing state includes one of a loaded state and an unloaded state, and the reference state includes the other of the loaded state and the unloaded state.

20. The shearography system of claim 18, comprising a processor connected to the camera,
wherein the processor is configured to process the intensity information obtained by the camera; and the processor is configured to calculate a relative phase difference according to the reference intensity information and the testing intensity information.

21. The shearography system of claim 20, comprising a processor configured to calculate an out-of-plane strain measurement according to the relative phase difference.

22. A method of non-destructive testing, the method comprising:
providing a camera, a testing object, and a light source in an optical path;
disposing an image plane in the optical path between the testing object and the camera;
illuminating, via a beam from the light source, a test area of the testing object;
reflecting the beam from the test area to the image plane;
reflecting the beam from the image plane to the camera;
capturing, via the camera, intensity information of the beam reflected from the image plane; and
identifying a deformation in the test area according to the intensity information;
wherein the test area of the testing object is speckless or quasi-speckless, and the image plane includes a surface configured for diffuse reflection that is disposed in the optical path between the test area and the camera.

23. The method of claim 22, wherein the diffuse surface of the image plane comprises a rough white surface.

24. The method of claim 22, comprising disposing a first polarizer in the optical path between either (i) the light source and the testing object, or (ii) the testing object and the image plane.

25. The method of claim 24, wherein the first polarizer comprises an orthogonal polarizer.

26. The method of claim 24, comprising disposing a second polarizer in the optical path between the other of the (i) the light source and the testing object, or (ii) the testing object and the image plane.

27. The method of claim 22, comprising disposing an orthogonal polarizer in the optical path between the testing object and the image plane.

28. The method of claim 26, wherein the second polarizer comprises an orthogonal polarizer.

29. The method of claim 22, comprising calculating an amount of out-of-plane strain of the testing object.

30. The method of claim 29, wherein the intensity information captured by the camera includes reference intensity information and testing intensity information; and, calculating the amount of out-of-plane strain comprises determining a phase difference from the reference intensity information and the testing intensity information.

31. The method of claim 24, wherein illuminating the testing object includes polarizing the beam via the first polarizer.

32. The method of claim 26, wherein reflecting the beam from the test area to the image plane comprises polarizing the beam via the second polarizer.

33. The method of claim 26, wherein the beam, as it reflects from the testing object to the image plane, includes specular portions and diffuse portions, and the second polarizer limits the effect of the diffuse portions.
